(19) United States
(12) Patent Application Publication
(10) Pub. No.: US 2025/0052183 A1
(43) Pub. Date: Feb. 13, 2025

(54) CHAMBER MIXER FOR AN EXHAUST AFTER-TREATMENT SYSTEM OF A MOTOR VEHICLE

(71) Applicant: DAIMLER TRUCK AG, Leinfelden-Echterdingen (DE)

(72) Inventors: Jens KIENZLE, Aidlingen (DE); Christoph SITTER, Ehningen (DE); Sinisa KONTIN, Stuttgart (DE); Moritz WIED, Tübingen (DE); Thomas BOLDT, Neu-Ulm (DE); Ralf WANDEL, Neustetten (DE)

(21) Appl. No.: 18/723,003

(22) PCT Filed: Dec. 20, 2022
(86) PCT No.: PCT/EP2022/087100

§ 371 Date: Jun. 21, 2024

(30) Foreign Application Priority Data
Dec. 23, 2021 (DE) 10 2021 006 331.7

(51) Int. Cl. F01N 3/28; B01F 23/213; B01F 25/10; B01F 25/314; B01F 25/421; B01F 35/90; B01F 35/92; F01N 3/20

(52) U.S. Cl. CPC F01N 3/2892; B01F 23/2132; B01F 25/103; B01F 25/3141; B01F 25/4231; B01F 35/92; F01N 3/2006; F01N 3/2066; B01F 2035/99; F01N 2610/02; F01N 2610/1453

(57) ABSTRACT

The invention relates to a chamber mixer (10) for an exhaust after-treatment system of a motor vehicle, wherein a first fluid (12) can flow through the internal volume (18) of the chamber mixer in a through-flow direction (26), said internal volume being delimited by a housing (16), wherein at least one housing side of the housing (16) is double-walled and has an outer wall (30) and an inner wall (32) which divides the internal volume (18) into an inner chamber (34) and an outer chamber (36), wherein the fluid flowing in through an inlet opening (22) can be separated into a main flow (38) flowing through the inner chamber (34) and an auxiliary flow (40) flowing through the outer chamber (36), wherein the main flow (38) can be acted upon by means of a flow device (48) with a double swirl (50) and with a fluid introduction device (56) with an introduction end (58) which is arranged in the outer chamber (36) and via which a second fluid (14) can be injected into the inner chamber (34) through an introduction opening (60) in the inner wall (32).

The invention relates to a chamber mixer for an exhaust after-treatment system of a motor vehicle according to claim 1.

Exhaust after-treatment systems are used to clean the combustion gases of a motor vehicle's internal combustion engine. In particular, the motor vehicle may be a car or a truck. The internal combustion engine can be designed as a diesel engine. Its combustion gas or exhaust gas usually contains nitrogen oxides, such as nitrogen monoxide and nitrogen dioxide. During exhaust after-treatment in a diesel engine, selective catalytic reduction is used in particular to reduce nitrogen oxides. For this purpose, a reductant—such as urea solution—is injected into the exhaust gas, which represents a first fluid, as a second fluid. The first fluid and the second fluid mix with each other and flow into an SCR catalytic converter. The urea solution decomposes into ammonia and water in the exhaust gas. A reaction takes place in the SCR catalytic converter, the products of which are water and nitrogen.

U.S. Pat. No. 10,024,217 B1 and U.S. Pat. No. 10,408,110 B2 both show a chamber mixer. A reductant is added to the exhaust gas in the chamber mixer and mixed together. Furthermore, CN 110 337 324 A shows another chamber mixer for after-treatment systems.

The object of the present invention is to provide a chamber mixer for an exhaust after-treatment system of a motor vehicle which is particularly compact and, in addition, enables particularly good mixing of exhaust gas with a reductant for high efficiency of the exhaust after-treatment.

This object is achieved by the subject matter of the independent patent claim. Advantages and advantageous embodiments of the invention are the subject of the dependent patent claims, the description and the figures.

The chamber mixer according to the invention is provided for an exhaust after-treatment system of a motor vehicle. The exhaust after-treatment system is used for the exhaust after-treatment of an internal combustion engine, in particular a diesel engine. The motor vehicle can be a car or a truck, for example.

The chamber mixer has an internal volume delimited by a housing. A first fluid can flow through the internal volume from an inlet opening arranged at one end of the internal volume on or in the housing to an outlet opening arranged at the other end of the internal volume on or in the housing along a through-flow direction. In the chamber mixer according to the invention, at least a second housing side is double-walled with an outer wall and an inner wall, which divides the internal volume into an inner chamber and an outer chamber located between the inner wall and the outer wall. Furthermore, in particular due to the design of the inlet opening, the first fluid flowing in through the inlet opening, in particular in gaseous form, can be divided into a main flow flowing through the inner chamber and an auxiliary flow flowing through the outer chamber. Furthermore, according to the invention, a flow device is provided by which the main flow can be subjected to a double swirl, in particular a symmetrical double swirl, in the through-flow direction. Furthermore, the chamber mixer comprises a fluid introduction device with an introduction end, which is arranged in the outer chamber and can thus be flowed around by the auxiliary flow in particular. A second, in particular liquid fluid, for example the reductant, can be injected into the inner chamber via the introduction end or at the introduction end through an introduction opening in the inner wall. Furthermore, a merging device is provided downstream in the through-flow direction, through which the main flow and the auxiliary flow can be guided into each other, in particular before reaching the outlet opening.

“Arranged at one end of the internal volume” is to be understood in particular as “arranged upstream in the direction of flow”. “Arranged at the other end of the internal volume” means in particular: “arranged downstream”. Thus, in particular, the outlet opening is arranged downstream in the direction of flow on the chamber mixer or its internal volume, which is formed by the inner chamber and outer chamber.

In other words, a chamber mixer according to the invention, which can be designed as a decomposition reactor, is presented, which has a flow device in the inlet opening, through which the fluid flow is divided into two parts or two partial main flows when passing through the flow device. In particular, the main flow is converted into a bidirectional flow by a double swirl plate of the flow device. The auxiliary flow passes between the inner wall and the outer wall and flows in particular around the area near the introduction end of the fluid introduction device. At the downstream end of both the inner and outer chambers, the main and auxiliary flows converge again and can leave the chamber mixer via the outlet opening.

The design of the inner chamber and/or the inner wall, for example in the form of a deflection element of the flow device, displaces the main flow or supports the symmetrical double swirl along the through-flow direction.

The impact of the double swirl on the main flow means that the two partial flows can be formed or are formed along the through-flow direction as two vortices of the first fluid flowing through, which run side by side. Their respective axis of rotation is essentially oriented along the through-flow direction. The two vortices that describe the double swirl are formed in particular at one end by the flow device and each run in particular along the longitudinal extension direction of the chamber mixer, which essentially coincides with the through-flow direction. The fluid of the respective vortex or first fluid, which is located in the respective air vortex, moves along the through-flow direction and also essentially circularly around the respective axis of rotation, thus essentially describing a spiral path. The two vortices each have a different direction of rotation, so that one rotates clockwise and the other counterclockwise.

The second fluid introduced, in particular the liquid one, evaporates into a gaseous phase within this double swirl formed in the main flow. Vaporization can thereby be advantageously improved by injection using the fluid introduction device and/or, for example, by applying heat. The second fluid can in particular be a reductant, whereby the fluid introduction end can thus introduce the reductant into the internal volume, in particular by injection. The first fluid in the form of an exhaust gas, which may in particular contain nitrogen oxides due to the combustion of diesel fuel, can be mixed with the reductant in the chamber mixer, whereby the mixture of first fluid and second fluid can be made to react in an SCR catalytic converter.

For example, when using urea as a reactant, a thermolysis and subsequent hydrolysis reaction can take place in the chamber mixer. Ammonia is thereby released from the urea to neutralize the nitrogen oxides. Thermolysis and hydrolysis take place in particular in the internal volume on the path along the chamber mixer in the through-flow direction.

One advantage of the chamber mixers according to the invention is that a complex mixer design for atomizing and/or vaporizing the second fluid is not required. In this way, mixing and vaporization and thus atomization of the second fluid can be achieved in a particularly advantageous manner by the chamber mixer according to the invention. It is therefore also possible for the chamber mixer to be designed in a particularly compact way and/or with few components.

Due to the double swirl, a particularly advantageous mixing between the first fluid and the second fluid now occurs, whereby exhaust after-treatment can be carried out in a particularly advantageous manner.

The chamber mixer can thus be used to advantageously bring an injected liquid reductant—the second fluid—into contact with the exhaust gas, i.e., the first fluid. The chamber mixer according to the invention has the advantage that a particularly high mixing homogeneity of the two fluids can be achieved. As a result of this mixing homogeneity, catalytic reduction of the exhaust gas (first fluid), in particular of the nitrogen oxides contained therein, can also be carried out in a particularly advantageous manner. Furthermore, the chamber mixer is designed in such a way that a particularly low counterpressure against the direction of flow in the first fluid is to be expected. Another advantage is that due to the division into the main flow and the auxiliary flow and the application of the double swirl to the main flow, deposit growth on the walls or on the housing of the chamber mixer can be avoided or is at least particularly low.

In an advantageous embodiment of the invention, the flow device comprises a double swirl plate arranged in a first partial inlet opening of the inlet opening or at the inlet opening. In other words, an element influencing the flow of the inflowing first fluid, the exhaust gas, is provided, the double swirl plate of the flow device, whose task is to influence the flow in particular in such a way that the application of the double swirl to the main flow according to the invention can take place in a particularly advantageous manner. The double swirl plate at least partially closes the inlet opening, whereby lamellae represent obstacles to the flow of the first fluid. In order to achieve a symmetrical double swirl, the orientation of the lamellae relative to the inlet opening is also symmetrical. This results in the advantage that it is particularly easy to influence the incoming exhaust gas or the first fluid to generate the double swirl.

In a further advantageous embodiment of the invention, the flow device has at least one deflection element arranged in the inner chamber and/or on the inner wall. Additionally, or alternatively, at least part of the inner wall is designed as a deflection element. In particular, the deflection element has a shape that is advantageous for forming the double swirl or for reinforcing the double swirl and/or for maintaining the double swirl. The deflection element can therefore also represent an obstacle to the flow of the first fluid. In other words, the flow device comprises a deflection element which is arranged in the inner chamber for conveying the double swirl of the main flow and is preferably formed on and/or through the inner wall. In this way, the deflection element can also be a curvature of the inner wall, for example, which has a radius of the double swirl, so that the first fluid or exhaust gas flowing towards the deflection element can flow along the inner wall and thus form a part or vortex of the double swirl. This results in the advantage that the flow device can be used particularly advantageously to generate, amplify and/or maintain the double swirl of the main flow.

In a further advantageous embodiment of the invention, the merging device has at least one through-hole opening on a part of the inner wall assigned to associated with the outlet opening. In other words, the downstream part of the inner wall is provided with through-hole openings through which the first fluid, for example of the auxiliary flow, can flow in order to join the main flow. The inner wall is thereby designed as a perforated metal sheet, for example, in particular with wing beading. This results in the advantage that the auxiliary flow can be merged with the main flow in a particularly simple and therefore fail-safe manner or that they can be guided into each other. The auxiliary flow in particular can thereby be guided into the main flow.

In a further advantageous embodiment of the invention, a heating device is provided by which the inner wall and/or the at least one further inner wall can be heated at least in a respective subarea in order to vaporize the second fluid. In other words, at least part of the wall delimiting the internal chamber can be heated or warmed, whereby the vaporization of the second fluid introduced into the internal volume by means of the fluid introduction device can at least be supported. This results in the advantage that the efficiency of the mixing of the first fluid with the second fluid and thus of the exhaust after-treatment can be improved in a particularly advantageous way.

In a further advantageous embodiment of the invention, the fluid introduction device is designed to inject a urea solution, in particular an aqueous urea solution. In other words, a urea solution is advantageously used as the second fluid, which can be conveyed or injected into the internal volume by the fluid introduction device. In other words, one embodiment of the fluid introduction device and in particular its introduction end, which may in particular have a nozzle, is adapted to convey and inject urea solution. For this purpose, for example, the nozzle, lines and/or at least one pump of the fluid introduction device can be adapted to a viscosity of the urea solution in order to be operated in a particularly advantageous manner. This results in the advantage that the chamber mixer can be used particularly advantageously for exhaust after-treatment.

In a further advantageous embodiment of the invention, beading is incorporated in the inner wall, which is oriented in the through-flow direction in such a way that mixing of the second fluid with the first fluid is favored. If the inner wall is preferably a metal sheet, this can be embossed with the beading. This results in the advantage that mixing of the second fluid with the first fluid can be improved in a particularly simple and/or cost-effective manner in addition to the double swirl, since, for example, the injected second fluid can be introduced particularly well into the main flow impinged with the double swirl when it hits the beading.

In a further advantageous embodiment of the invention, a chamber contour or a chamber cross-section of the inner chamber tapers downstream. This favors the mixing of the first fluid with the second fluid. This results in the advantage that the mixing of the first fluid with the second fluid and thus the exhaust after-treatment can be carried out particularly efficiently.

Furthermore, the chamber wall of the inner chamber, i.e., the inner wall and/or the at least one further inner wall, advantageously has no edges and/or obstructions, as a result of which a particularly low counterpressure can be realized when the main flow, in particular, but also the auxiliary flow, for example, flows through the chamber in the direction of flow.

In a further advantageous embodiment of the invention, the inlet opening and the outlet opening are arranged on one side of the housing. In other words, the two openings are oriented on the same side of the housing. This can result in the advantage that the housing can be designed to be particularly compact.

Further advantages, features and details of the invention are apparent from the following description of preferred embodiments and from the drawing. The features and combinations of features mentioned above in the description as well as the features and combinations of features mentioned below in the description of the figures and/or shown alone in the figures can be used not only in the combination indicated in each case, but also in other combinations or on their own, without departing from the scope of the invention.

The drawings show:

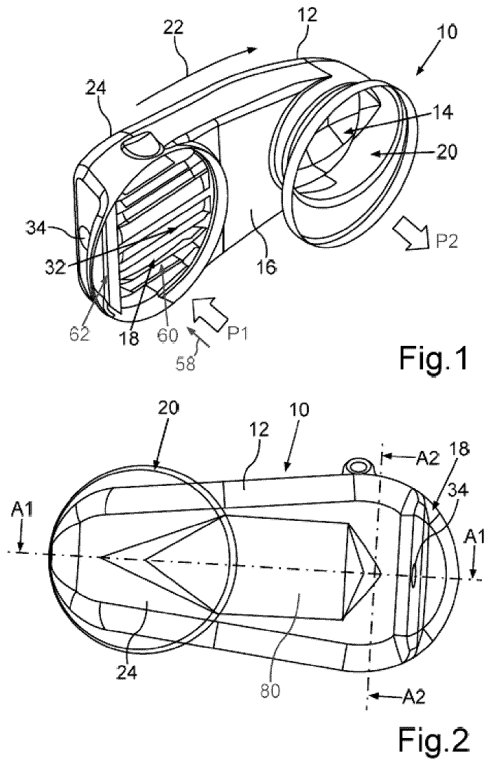

FIG. 1 A schematic perspective view of a chamber mixer for an exhaust after-treatment system of a motor vehicle;

FIG. 2 A schematic top view of the chamber mixer according to FIG. 1;

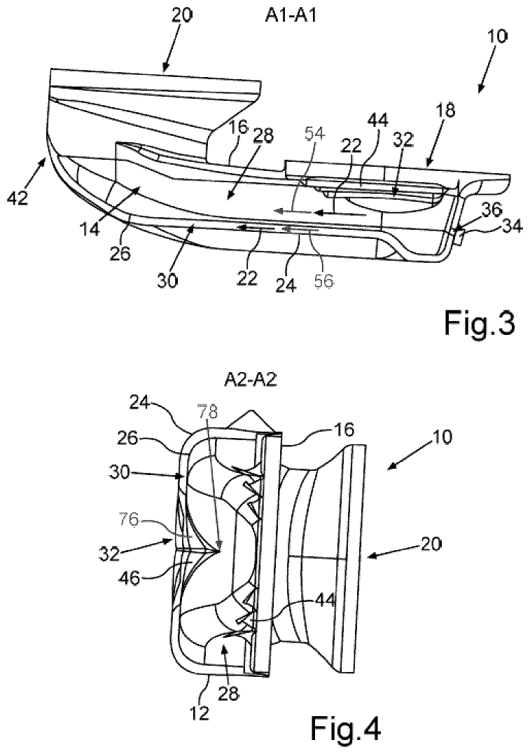

FIG. 3 A sectional side view of the chamber mixer according to the previous figures;

FIG. 4 A sectional front view of the chamber mixer according to the previous figures;

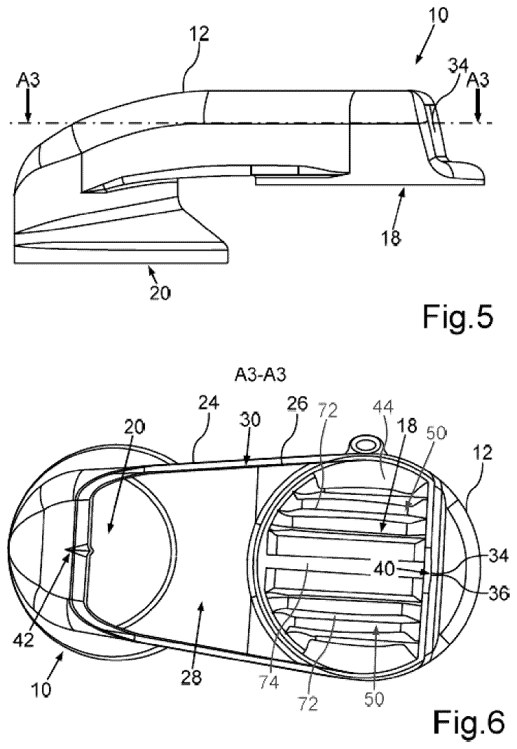

FIG. 5 A schematic side view of the chamber mixer according to the previous figures;

FIG. 6 A sectional top view of the chamber mixer according to the previous figures;

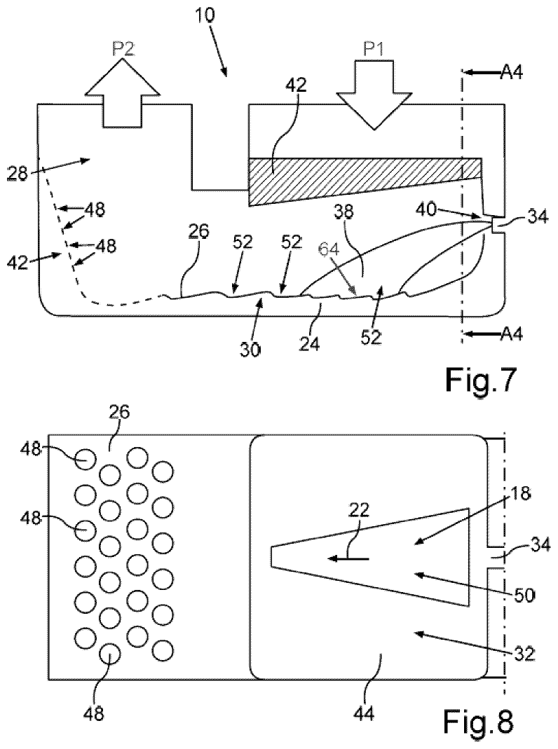

FIG. 7 A further sectional side view of another embodiment of the chamber mixer;

FIG. 8 A schematic top view of an inner wall as well as a double swirl plate of the chamber mixer according to FIG. 7; and

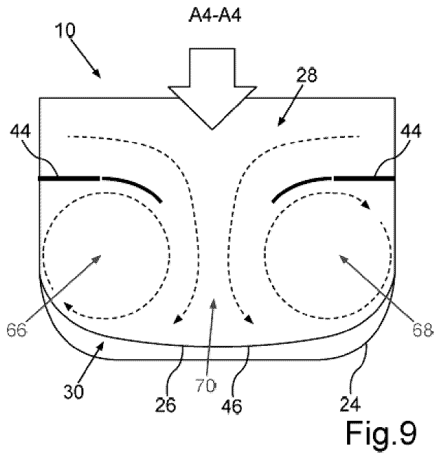

FIG. 9 A schematic sectional front view of the chamber mixer according to FIG. 7.

FIG. 1 shows a schematic perspective view of a chamber mixer 10 for an exhaust after-treatment system of a motor vehicle. The exhaust after-treatment system is used for exhaust after-treatment, in which combustion gases from an internal combustion engine of the motor vehicle are cleaned. In this way, emissions can be reduced during use of the motor vehicle, which may in particular be a passenger car or a truck.

In particular, the exhaust after-treatment system can be operated on the basis of selective catalytic reduction if the internal combustion engine is a diesel engine. The exhaust after-treatment can thus reduce nitrogen oxides, in particular nitrogen monoxide and nitrogen dioxide, from the exhaust gas, which can flow through the chamber mixer 10 as the first fluid 58, in at least one SCR catalytic converter. The exhaust after-treatment in the chamber mixer 10 is advantageously initiated by bringing a reductant, which is injected into the chamber mixer 10 as a second fluid 38, into contact with the exhaust gas, i.e., the first fluid 58. The mixture of first and second fluid flows from the chamber mixer 10 into the at least one SCR catalytic converter, whereupon a selective catalytic reaction known per se takes place in the SCR catalytic converter.

It has been shown in the prior art that a low mixing homogeneity between the fluids leads to poor exhaust gas after-treatment values or that chamber mixers are used in which the fluid can only flow with a high counterpressure. This favors deposit growth and thus deposits from the fluid in the previous chamber mixers.

These disadvantages of the prior art can be avoided by the chamber mixer 10 according to the invention as shown.

For this purpose, the chamber mixer 10 has an internal volume 14 delimited by a housing 12. As indicated by the first arrow P1 shown in FIG. 1, the first fluid 58 flows into the internal volume 14 through an inlet opening 18 arranged at one end of the internal volume 14 on a first housing side 16. Together with the mixed second fluid 38, the first fluid 58 flows to an outlet opening 20 arranged at the other end of the internal volume 14 on the (same) first housing side 16 along a through-flow direction 22 through the internal volume 14 and, as indicated by a second arrow P2, out of the outlet opening 20 from the internal volume 14 and thus out of the housing 12 of the chamber mixer 10.

In the chamber mixer 10, at least a second housing side 80 of the housing 58 is double-walled with an outer wall 24 and an inner wall 26 shown in FIGS. 3, 4, 6, 7 and 9, which divides the internal volume 14 into an inner chamber 28 and an outer chamber 30 located between the inner wall 26 and the outer wall 24, which can be seen, for example, in FIG. 3. The second housing side 80 of the housing 12 and is preferably designed opposite the inlet opening 18 and the outlet opening 20.

The chamber mixer 10 is further designed so that the first fluid 58—the exhaust gas of the internal combustion engine—flowing in through the inlet opening 18, in particular in gaseous form, can be divided, or is divided, in particular through the inlet opening 18, into a main flow 54 flowing through the inner chamber 28 and an auxiliary flow 56 flowing through the outer chamber 30. For this purpose, the inlet opening 18 has a first partial inlet opening 42 for the inner chamber 28 with its main flow 54 and a second partial inlet opening 62 for the outer chamber 30 with its auxiliary flow 56. Once the first fluid 58 has flowed into the housing 12 through the inlet opening 14 and the first and second partial inlet openings 60 and 62, the first fluid 58 is diverted into the main flow 54 and the auxiliary flow 56, respectively, in the through-flow direction 22. The outer chamber 30 initially runs along a third housing side which, starting from the inlet opening 18, forms an angle with the second housing side 80 and merges into it.

Furthermore, a flow device 32 is provided, by means of which the main flow 54 can be subjected to a double swirl 70, in particular a symmetrical double swirl, in the through-flow direction 22. This means that the first fluid 58, when flowing transversely to the through-flow direction 22 downstream through the inner chamber 28, is divided downstream of the first partial inlet opening 42 in the inner chamber 28 into a clockwise swirling first partial main flow 66 and a counterclockwise swirling second partial main flow 68 of the main flow 54. In each of the two partial main flows 66 and 68, the first fluid 58 or a fluid mixture of the first and second fluids 58 and 38 essentially moves in a spiral as it flows through the inner chamber 28.

Furthermore, a fluid introduction device 34 with an introduction end 36 is provided in the third housing side. The introduction end 36 is arranged in the outer chamber 30 and can therefore be flowed around by the auxiliary flow 56. A second fluid 38, in particular a liquid fluid—the reductant, such as urea solution—can be injected into the inner chamber 28 through an introduction opening 40 in the inner wall 26 via the fluid introduction device 34. Furthermore, a merging device 42 is provided downstream in the through-flow direction 22, by means of which the main flow 54 with its two partial main flows 66 and 68 and the auxiliary flow 56 can be guided into one another and thus mixed with one another. The merging device 42 is essentially provided upstream of the outlet opening 20 in the internal volume 14. The mixed fluids 58 and 38 are deflected in the internal volume 14 in the area of the merging device 42 at a fourth housing wall 64 and then flow out of the outlet opening 20 of the housing 12 and thus out of the chamber mixer 10. The merging device 42 has at least one through-hole opening 48, through which the auxiliary flow 56 enters the inner chamber 28. The fourth housing wall 64 thereby extends from the second housing side 80 to the outlet opening 20.

FIG. 2 shows a schematic top view of the chamber mixer 10 according to FIG. 1 and serves in particular to illustrate the sections shown in FIGS. 3 and 4 along the line A1-A1 and the line A2-A2.

Thus, FIG. 3 shows the chamber mixer 10 according to the two preceding figures in a schematic sectional side view along the line A1-A1, whereby the two chambers formed from the internal volume 14, the inner chamber 28 and the outer chamber 30, are particularly advantageously recognizable here. According to FIG. 3, the through-flow direction 22 essentially extends along a longitudinal extension direction of the chamber mixer 10, whereby the respective fluid 58 and 38 can deviate from the longitudinal extension direction of the chamber mixer 10 in a respective transverse extension direction, in particular in the vicinity of the inlet opening 18 and the outlet opening 20. In the embodiment shown, the first fluid 58 is deflected downstream of the inlet opening 18 by an angle of approximately 90° in the through-flow direction 22 and the first fluid 58 and the second fluid 38 mixed with the first fluid 58 are also deflected upstream of the outlet opening 20 by an angle of 90° to the through-flow direction 22. It goes without saying that deflection angles are also possible. The first fluid 58 and second fluid 38 that are mixed together flow out of the outlet opening 20 from the chamber mixer 10 as a fluid mixture.

For example, the flow device 32 may include a double swirl plate 44 arranged in the first partial inlet opening 60 of the inlet opening 18. In a first embodiment according to FIGS. 1 to 6, the double swirl plate 44 has a plurality of lamellae 72 which are oriented in the longitudinal direction or through-flow direction 22 and are set to generate the clockwise swirl of the first partial main flow 66 and the counterclockwise swirl of the second partial main flow 68 correspondingly with respect to the first fluid 58 flowing towards the inlet opening 18. The first fluid 58 flows through openings 50 between the lamellae 72 into the chamber mixer 10, where it is deflected accordingly. The second partial inlet opening 62 is free of a flow device. Furthermore, as shown in a schematic, sectional frontal view of FIG. 4 along A2-A2, the flow device 32 can have at least one deflection element 46, which is arranged in the inner chamber 28 and/or on the inner wall 26. The deflection element 46 is used in particular to apply the double swirl 70 to the main flow 54 or to reinforce or maintain it and can also guide it downstream towards the outlet opening 20. The deflection element 46 has an essentially triangular cross-section, with one edge 78 of the deflection element 46 facing the inlet opening 18. The edge 78 of the deflection element 46 essentially begins in the central area of the inlet opening 18 and extends in the internal volume 14 to the outlet opening 20. The deflection element 46 is formed by a recess 76 in the second housing side 80, which leads to the essentially triangular cross-section of the inner wall 26 and projects into the internal volume 14. It can be seen in particular in FIGS. 3 and 4 that the outer wall 24 also has the triangular cross-section and thus the outer chamber 30 also has the triangular cross-section in the area of the edge 78.

FIG. 5 shows a schematic side view of the chamber mixer 10, with the sectional plane A3-A3 shown in FIG. 6 marked.

FIG. 6 shows a schematic top view of the chamber mixer 10. The angled lamellae 72 of the double swirl plate 44 are particularly clearly visible, as is a web 74 of the double swirl plate 44 arranged centrally between the lamellae 72. The web 74 ensures improved stability of the double swirl plate 44. There are also openings 50 between the web 74 and the lamellae 72 to the left and right of it. Furthermore, it can be seen that, in contrast to the first partial inlet opening 60 with its double swirl plate 44, the second partial inlet opening 62 has no flow device and the first fluid 58 can flow into the outer chamber 30 without being deflected. In particular, it can be seen from FIG. 6, as also from FIG. 2, that the internal volume 14 of the chamber mixer 10 has a decreasing cross-section along the through-flow direction 22 from the inlet opening 18 to the outlet opening 20. Overall, the housing 12 and thus the internal volume 14 tapers from the inlet opening 18 towards the outlet opening 20, so that a velocity of the first fluid 58 and the second fluid 38 increases in the internal volume 14 of the chamber mixer 10 from the inlet opening 18 towards the outlet opening 20, whereby an improved mixing of the first fluid 58 with the second fluid 38 can be achieved.

FIGS. 7 to 9 show a further embodiment of the chamber mixer 10, with FIG. 7 showing the chamber mixer 10 in a sectional view analogous to that of FIG. 3. Identical components or components with the same effect are marked with the same reference symbols as in the embodiment shown in FIGS. 1 to 6. FIG. 7 shows how the second fluid 38 can be introduced into the inner chamber 28 by the fluid introduction device 34 through the introduction opening 40 via the introduction end 36. In particular, the introduction can take place in liquid form so that the liquid second fluid 38 can come into contact with the inner wall 26. In order for the second fluid 38 to be advantageously used for the exhaust after-treatment, it should advantageously mix with the first fluid 58—the exhaust gas—in the gaseous phase in the double swirl 70. For this purpose, a heating device, not shown in more detail, can advantageously be provided, which heats the inner wall 26 at least in a subarea 64, in particular the area in which the second fluid 38 meets the inner wall 26, whereby the evaporation of the second fluid 38 and thus its transition from the liquid to the gaseous phase is at least favored.

FIG. 7 also shows beading 52 formed on the inner wall 26. The beading 52 is oriented essentially transverse to the through-flow direction 22 such that mixing of the first fluid 58 with the second fluid 38 is favored, since, for example, in addition to the double swirl 70, turbulence can be formed at the beading 52 in the inner chamber 34 in the fluid or in the mixture of the first and second fluids 58 and 38.

The fluid introduction device 34 is advantageously designed so that a second fluid 38, in particular an aqueous urea solution, can be injected. The urea solution can be converted to ammonia in a chemical reaction in the chamber mixer 10, so that the ammonia can advantageously bind or neutralize the nitrogen oxides in the exhaust gas in an SCR catalytic converter downstream of the chamber mixer 10. Furthermore, the merging device 42 has a plurality of through-hole openings 48 such that the first fluid 58 can enter the inner chamber 34 from the outer chamber 30 through the through-hole openings 48 and mix with the first and second fluids 58 and 38 in the inner chamber 34, thereby allowing further enhanced mixing of the first and second fluids 58 and 38.

FIG. 8 shows a schematic top view of the double swirl plate 44 in a second embodiment according to FIGS. 7 to 9 in the first partial inlet opening 60 of the inlet opening 18, which is arranged above the inner wall 26 provided with the through-hole openings 48 in the viewing direction of the figure. A single opening 50 can thereby be seen here in particular, which tapers in the downstream direction of the through-flow direction 22 towards the outlet opening 20 and is arranged symmetrically transversely thereto in an alternative flow device.

FIG. 9 shows the section A4-A4, the position of which at the chamber mixer 10 is shown in FIG. 7, with the arrows indicating the first partial main flow 66 and the second partial main flow 68 of the double swirl 70 of the first fluid 58 and the fluid mixture respectively. In order to advantageously maintain or increase the double swirl 70 or to favor a mixture of the first fluid 58 and the second fluid 38, a cross-section of the inner chamber 28 can become smaller, especially downstream. At least the inner chamber 28, for example, can thereby taper downstream.

The first partial main flow 66 and the second partial main flow 68 of the double swirl 70 of the first fluid 58 or of the fluid mixture are generated by lamellae 72 in the opening 50 of the double swirl plate 44, which are bent inwards in the direction of the inner chamber 28, and also by the inner wall 26, which has a concave shape, at least at its edges. As shown in section A4-A4, the two lamellae 72 of the opening 50 do not extend as far into the inner chamber 34 as in the direction of the outlet opening 20 of the chamber mixer 10, as can be seen in FIG. 7.

Through the chamber mixer 10 shown in the figures, it is possible to contribute in a particularly advantageous way to exhaust after-treatment by means of the exhaust after-treatment system.

This results in several advantages. For example, the chamber mixer 10 can be designed to be particularly compact, so that the installation volume is particularly small. Furthermore, additional openings and/or holes can be dispensed with as an obstruction point, which can reduce deposition growth of, for example, the urea solution on the surfaces of the housing 12 in contact with the inner chamber 28 and the outer chamber 30. In addition, the overall sturdiness of the chamber mixer 10 can be increased, for example, by dispensing with an extra mixing device in the internal volume 14. Furthermore, the internal volume can essentially be formed without edges and/or obstructions, which enables a particularly low counterpressure when flowing through in the through-flow direction 22. Thus, the chamber mixer 10 shown here results in a particularly advantageous exhaust after-treatment.

### LIST OF REFERENCE SIGNS

10 Chamber mixer
12 Housing
14 Internal volume
16 Housing side
18 Inlet opening
20 Outlet opening
22 Through-flow direction
24 Outer wall
26 Inner wall
28 Inner chamber
30 Outer chamber
32 Flow device
34 Fluid introduction device
36 Introduction end
38 Second fluid
40 Introduction opening
42 Merging device
44 Double swirl plate
46 Deflection element
48 Through-hole opening
50 Opening
52 Beading
54 Main flow
56 Auxiliary flow
58 First fluid
60 First partial inlet opening
62 Second partial inlet opening
64 Subarea
66 First partial main flow
68 Second partial main flow
70 Double swirl
72 Lamella
74 Web
76 Recess
78 Edge
80 Second housing side
P1 Arrow
P2 Arrow

1. Chamber mixer (10) for an exhaust after-treatment system of a motor vehicle, wherein a first fluid (58) can flow through the internal volume (14), which is delimited by a housing (12), from an inlet opening (18) arranged at one end of the internal volume (14) in the housing (12) to an outlet opening (20) arranged at the other end of the internal volume (14) in the housing (12) in a through-flow direction (22), and at least a second housing side (80) of the housing (12) is of double-walled design with an outer wall (24) and an inner wall (26), which divides the internal volume (14) into an inner chamber (28) and an outer chamber (30) located between the inner wall (26) and the outer wall (24), and the first fluid (58) flowing in through the inlet opening (18) can be divided into a main flow (54) flowing through the inner chamber (28) and an auxiliary flow (56) flowing through the outer chamber (30), and a flow device (32) is provided, by means of which the main flow (54) can be subjected to a double swirl (70) in the through-flow direction (22) and with a fluid introduction device (34) with an introduction end (36), which is arranged in the outer chamber (30) and via which a second fluid (38) can be injected into the inner chamber (28) through an introduction opening (40) in the inner wall (26), and a merging device (42) is provided downstream in the direction of flow (22), through which the main flow (54) and the auxiliary flow (56) can be guided into one another.

2. Chamber mixer (10) according to claim 1,
characterized in that
the flow device (32) comprises a double swirl plate (44) arranged in a first partial inlet opening (60) of the inlet opening (18).

3. Chamber mixer (10) according to claim 1,
characterized in that
the flow device (32) has at least one deflection element (46) arranged in the inner chamber (28) and/or on the inner wall (26) and/or at least a part of the inner wall (26) is designed as a deflection element (6).

4. Chamber mixer (10) according to claim 1,
characterized in that
the merging device (42) comprises at least one through-hole opening (48) at a part of the inner wall (26) associated with the outlet opening (20).

5. Chamber mixer (10) according to claim 1,
characterized in that
a heating device is provided, by means of which the inner wall (26) can be heated at least in a respective subarea (64) in order to vaporize the second fluid (38).

6. Chamber mixer (10) according to claim 1,
characterized in that
the fluid introduction device (34) is designed for injecting a, in particular aqueous, urea solution.

7. Chamber mixer (10) according to claim 1,
characterized in that
beading (52) is incorporated on the inner wall (26), said beading being oriented with respect to the through-flow direction (22) in such a way that mixing of the first fluid (58) with the second fluid (38) is favored.

8. Chamber mixer (10) according to claim 1,
characterized in that
the one chamber contour of the inner chamber (28) tapers downstream in order to favor the mixing of the first fluid (58) with the second fluid (38).

9. Chamber mixer (10) according to claim 1,
characterized in that
the inlet opening (18) and the outlet opening (20) are arranged on a first housing side (16).
